(19) United States
(12) Patent Application Publication
(10) Pub. No.: US 2002/0133409 A1
(43) Pub. Date: Sep. 19, 2002

(54) Transaction history system and method

(75) Inventors: Yoshiaki Sawano, Zama-shi (JP); Mari Ara, Yamato-shi (JP)

Correspondence Address: A. Bruce Clay, IBM Corporation T81/503, PO Box 12195, Research Triangle Park, NC, 27709, US

(73) Assignee: International Business Machines Corporation, Armonk, NY

(21) Appl. No.: 10/094,046

(22) Filed: Mar. 8, 2002

(30) Foreign Application Priority Data
Mar. 15, 2001 (JP) 2001-74483

(51) Int. Cl. G06F 17/60

(52) U.S. Cl. 705/16

(57) ABSTRACT

An ATM system makes transaction history information for display on an on-screen display section of an ATM, based on transaction history data of a customer's account which is obtained from a host server in response to a request from the ATM when the customer performs a given operation. The information displayed in the on-screen display section contains identification marks which indicate whether each transaction in the transaction history is recorded, unrecorded, or unconfirmed.

### FIELD OF THE INVENTION

The present invention relates to a transaction system, terminal, and history output apparatus which are suitable to allow customers to check the transaction history of their accounts in banks and other financial institutions.

### BACKGROUND ART

As is well known, banks and other financial institutions issue passbooks to the customers who have transaction accounts with them, and print out transaction historys such as credits and debits on the passbooks. A printout of a transaction history on a passbook, i.e., passbook updating, is made each time the customer presents the passbook to a bank counter or inserts the passbook in an ATM (Automatic Teller Machine) or dedicated passbook update machine installed at financial institutions or elsewhere. Naturally, what is entered at this time is that part of the transaction history which has not been recorded on the passbook.

Also, when a customer inserts a cash card which has been issued together with a passbook in an ATM for a deposit or withdrawal, the balance in the transaction account instead of transaction history is displayed or printed out on an itemized statement.

However, with the conventional forms described above, if a customer does not carry his/her passbook, he/she cannot update his/her passbook and thus cannot know his/her transaction history.

Additionally, ATMs installed recently in various places such as convenience stores often do not have the capability to accept a passbook and can handle only transactions via cash cards. With such cash-card-only ATMs, customers can only check their account balances and thus cannot know their transaction history.

Therefore, when a customer wants to check, for example, whether a specific direct debit or direct deposit has been made, the customer has to update his/her passbook by bringing it to an ATM which can handle passbooks within service hours. This is not convenient for the customer.

### SUMMARY OF THE INVENTION

The present invention provides a transaction system, terminal, and history output apparatus which allow customers to know their transaction history even if they do not carry their passbook. With this object in view, a transaction system according to the present invention consists of a terminal such as an ATM for customer transactions and a server for information about transaction accounts of the customers. The server possesses transaction history data concerning transaction accounts and data for identifying whether each transaction was made by a customer himself/herself. In response to a particular operation by a customer, the terminal outputs history information about the transactions that were not made by the customer himself/herself. These transactions include, for example, direct deposits to the transaction account and direct debits from the transaction account other than made by the customer himself/herself. The transactions made by the customer himself/herself include not only transactions through terminals such as ATMS, but also transactions at bank counters. If the processes performed by the customer on terminals are included in the concept of “transaction,” the processes of updating a passbook performed by the customer himself/herself and the output processes of similar transaction history information performed by the customer himself/herself in the past can be regarded as transactions (processes) made by the customer himself/herself.

In this way the customer can know the history of the transactions not made by himself/herself. The output form of this transaction history can be shown on a display section which displays images, and probably can also be printed out on an itemized statement issued by a terminal such as an ATM.

A transaction terminal according to the present invention accepts an input of account information for identification of a transaction account, by reading magnetic information from a cash card or the like, accepting a transaction account number, etc. through specific-information accepting means. Then it accepts specification of transaction details such as a deposit or withdrawal with respect to the transaction account through transaction detail accepting means and executes a transaction based on the specified transaction details through transaction executing means. The transaction here may not only be a deposit or withdrawal, but also a direct deposit or any various other transactions (processes) which do not involve a deposit or withdrawal. Also, through history data receiving means, the transaction terminal identifies a transaction account based on the account information and receives, from an external database provided on a server or the like, at least that part of transaction history data of the transaction account which has not been output before. These transactions include transactions whose history data was output as the customer updated his/her passbook and transactions for which the customer outputted similar transaction history information in the past. Then, through information output means, the transaction terminal outputs yet-to-be-output transaction information which has not been output before.

The information output means may output the yet-to-be-output transaction information when the transaction executing means is executing a transaction such as a deposit or withdrawal, based on specified transaction details. More specifically, it can output yet-to-be-output transaction information when the transaction executing means is performing processes, such as money counting for a deposit or withdrawal, which involves mechanical operations of the transaction terminal, or when it is performing time-consuming processes, such as a query to a server, which would conventionally constitute a waiting time during which the customer would perform no operation.

The history data receiving means may be made to receive transaction history data which has not been output before and which has been extracted from transaction history data of the transaction account. That is, the transaction history data which has not been output before may be extracted and transferred to the transaction terminal from the external database.

On the other hand, the information output means may be made to output the yet-to-be-output transaction information, based on the transaction history data of the transaction account and identification data for identifying whether any output has been made for each transaction, received by the history data receiving means. In this case, instead of making the yet-to-be-output transaction information to be extracted on the side of the external database, the transaction terminal will extract and output the yet-to-be-output transaction information based on the received history data and identification data.

If the information output means outputs at least the yet-to-be-output transaction information, it may be made to output information about unrecorded transactions yet to be entered in the passbook, and other transaction-related information as well. In that case, however, it is preferable that the yet-to-be-output transaction information and other transaction information can be distinguished easily.

Also, the information output means described above may not necessarily output transaction details that have not been output before, but it may output information only about the existence of transactions for which no output has been made before. Then the customer who received the output can take an action such as outputting the yet-to-be-output transaction information or entering the transaction history in his/her passbook.

Furthermore, regarding the output form of yet-to-be-output transaction information, in addition to display on a screen of the transaction terminal, itemized statement issuing means may issue an itemized statement by printing out transaction information about the transactions executed by the transaction executing means and the yet-to-be-output transaction information.

A transaction history output apparatus according to the present invention accepts a card that stores the transaction account number of a customer and refers to an external database for the transaction history of the transaction account. Then, information about unconfirmed transactions yet to be confirmed by the customer is output from the referenced transaction history data.

In addition to the information about unconfirmed transactions, it is also possible to output information about unrecorded transactions yet to be entered in the passbook as well as identification information which distinguishes between the information about unconfirmed transactions and the information about unrecorded transactions.

Also, the transaction history output apparatus may output information about a predetermined number of transactions, for example, the latest N transactions, by attaching identification information which distinguishes between the unconfirmed transactions and other transactions (i.e., confirmed transactions) among the predetermined number of transactions.

The transaction history output apparatus may be a dedicated apparatus which outputs transaction histories or a transaction terminal which also processes other transactions such as withdrawals.

Incidentally, although the transactions made by the customer himself/herself may be treated as confirmed transactions, the criteria for Confirmed/Unconfirmed status may be changed, as required, from the viewpoint of outputting transaction history for the purpose of making customers confirm transactions. Besides, the transactions for which yet-to-be-output transaction information has been output before may be treated as confirmed transactions.

Also, the transactions requested or registered by the customer in advance such as utility charges, rent, and loan payments may be treated as transactions confirmed (or recognized) by the customer and other direct debits and direct deposits may be treated as unconfirmed transactions.

A server according to the present invention accepts a request from a terminal operated by a customer and makes a data extraction section extract data about a transaction account of the customer from a data storage section, based on the request, and output the extracted data to the terminal. The data storage section stores the data including history information about the transactions on the transaction account of the customer, output information indicating whether or not the transactions contained in the history information have been output by the data extraction section, and record information indicating whether or not the history data is recorded on a passbook which records transaction history of the transaction account of the customer.

The data extraction section may output that part of the transaction history information which, according to the output information, has not been output before. Also, the data extraction section may output at least the output information out of the output information and the record information by attaching it to the history information.

The present invention can be seen as a transaction history display method for determining whether the type of unrecorded transactions on the transaction account of the customer is a preset type and displaying the history of the transactions determined to be of the preset type.

It is also possible to display the history of the transactions of other types together with the history of the transactions determined to be of the preset type by attaching identification information for distinguishing between them.

For example, if transactions not made by the customer himself/herself are of the preset transaction type, the history of the transactions determined as not having been made by the customer himself/herself will be displayed primarily and the history of the other types of transaction, i.e., the transactions made by the customer himself/herself may be displayed in an identifiable form with the addition of identification marks or the like.

Of course other settings may be used. For example, it is also possible to display transaction history such as the one described above only for the type of transaction specified (set) by the customer in advance. This is suitable, for example, when the customer wants to know whether a specific loan payment (direct debit) has been made. Incidentally, the customer setting of a transaction type for which history will be displayed may be made directly on a transaction terminal or may be registered in advance with a system of the financial institution or in the magnetic recording section of a cash card, etc.

If the present invention is seen as a computer program product comprising a computer usable medium having computer program logic recorded thereon, the computer program causes the execution of an acceptance process of accepting an external input of information for identification of a transaction account and identifying the transaction account, a reference process of referring to an external server or an imported database for the transaction history of the transaction account, and an information output process of outputting information about transactions other than those made by the customer himself/herself, based on the transaction history referenced.

The computer program product comprising a computer usable medium having computer program logic recorded thereon may further comprise a determining process of determining whether a passbook recording the transaction history of the transaction account is input in the computer and make the information output process to be executed if it is determined that the passbook is not input.

Also, the computer program product comprising a computer usable medium having computer program logic recorded thereon may further comprise a menu presentation process of presenting a menu of processes including the information output process and a menu specification process of accepting the specification of a process to be executed on the computer from among the processes presented on the menu. Then, even if the process specified in the menu specification process is a withdrawal process or a process other than the information output process, the computer program may make the information output process to be executed during the execution of the specified process.

Furthermore, it is possible to indicate the existence of any transactions other than the ones made by the customer himself/herself, make a request to specify whether to output the transaction history, and make the information output process to be executed if the transaction history is specified to be output.

### BRIEF DESCRIPTION OF THE DRAWINGS

The foregoing and other aspects of the invention will become more apparent from the following description of specific embodiments thereof and the accompanying drawings which illustrate, by way of example only, the principles of the invention:

FIG. 1 is a diagram showing the configuration of the ATM system according to this embodiment;

FIG. 2 is a diagram showing an example of a transaction history display on an ATM screen;

FIG. 3 is a diagram showing the flow of the processes executed by the ATM which produces a display as shown in FIG. 2;

FIG. 4 is a screen example displayed on the ATM during the processing shown in FIG. 3;

FIG. 5 is a screen example displayed on the ATM after the screen of FIG. 4;

FIG. 6 is a diagram showing another example of transaction history display on the ATM screen;

FIG. 7 is a diagram showing still another example of transaction history display on the ATM screen; and

FIG. 8 is a diagram showing an example of an itemized statement with transaction history information printed on it.

### DETAILED DESCRIPTION OF THE INVENTION

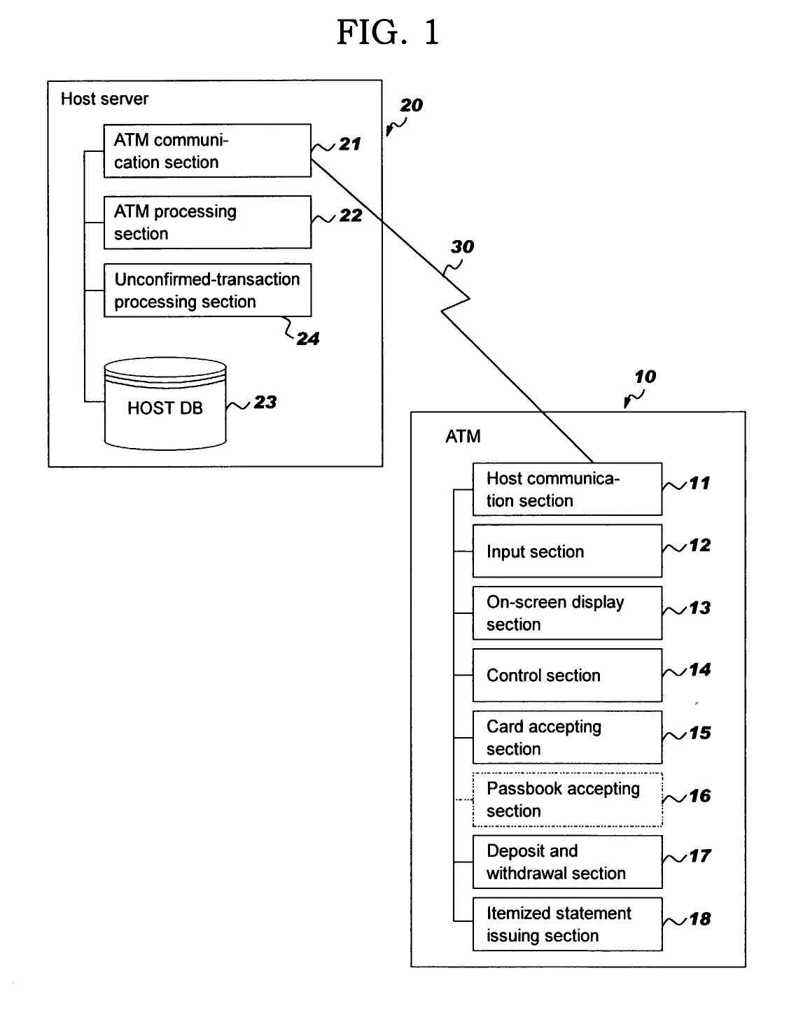

FIG. 1 is a diagram illustrating the configuration of the ATM system according to this embodiment. The ATM system consists of ATMs (terminals, computer devices) 10 installed in various places such as financial institutions and convenience stores and a host server (server) 20 which manages the data handled by individual ATMs. The ATMs 10 and host server 20 are connected by a leased line 30 or the like, allowing bidirectional data communication.

The ATM 10 comprises, a host communication section 11 for conducting data communication with the host server 20, an input section (specific-information accepting means and transaction detail accepting means) 12 such as a touch panel for customers to perform input operations, an on-screen display section (display section, information output means, and history output section) 13 provided with a touch panel serving as the input section 12, a control section (history data receiving means, transaction executing means, and data reference section) 14 for controlling the processes and operation of the ATMs 10 in accordance with input operations in the input section 12, a card accepting section 15 for accepting a cash card (card) inserted by a customer and reading necessary information from the magnetic data recording section of the cash card, a deposit and withdrawal section 17 for customers to deposit and withdraw cash, and an itemized statement issuing section (information output means, itemized statement issuing means, and history output section) 18 for issuing an itemized statement by printing out transaction information about the transactions made by the customer on the ATM and the balance.

If the ATM 10 is not a card-only machine and can accept a multi-page passbook made of paper, it further comprises a passbook accepting section 16 for accepting a passbook inserted by a customer and entering (printing) transaction information such as deposits and withdrawals in addition to the configuration described above.

On the other hand, the host server 20 comprises an ATM communication section 21 for carrying out data communication with individual ATMs 10, an ATM processing section (request accepting section) 22 for performing various processes in response to requests from the ATMs 10, a host database (HOST DB: external database and data storage section) 23, and an unconfirmed-transaction processing section 24.

The host database 23 stores history data (history information) of the transactions on transaction accounts as information (data) about the transaction accounts of customers. The transactions for which history data is stored include:

(1) deposits and withdrawals made by customers themselves on their transaction accounts at bank counters or on ATMs (not necessarily the ATM 10 with the configuration shown in FIG. 1) in various places;

(2) transfers from customers' transaction accounts to other transaction accounts made by the customers themselves at bank counters or on ATMs in various places;

(3) direct debits from transaction accounts, such as those for various bill payments registered by the customers in advance; and

(4) direct deposits (salary deposits, etc.) to the customers' transaction accounts from other transaction accounts, ATMs, bank counters, etc.

Data about each transaction contains passbook update information (record information) which indicates whether the passbook record has been updated and confirmation information (identification data, identification information, output information) which identifies whether the customer has confirmed the transaction (outputted transaction history) in addition to information about transaction details such as a transaction date/time and amount. The passbook update information and confirmation information are attached to the transaction data as flags, pointers in a table, etc.

Regarding the transactions confirmed by the customer, the criteria for Confirmed/Unconfirmed status may be changed, as required. According to this embodiment, however, the criteria has been set such that confirmed transactions will include the transactions which have already been recorded on the passbook, the transactions made by the customer himself/herself as described in (1) and (2) above, and the transactions whose transaction history has been displayed on an ATM 10 (as described later) among the transactions described in (3) and (4) above.

When a particular operation (described later) is performed on the side of an ATM 10, the unconfirmed-transaction processing section 24 searches the history data in the host database 23 and extracts the history data of the transactions that satisfy given criteria, which include:

a) a given number (e.g., 10) of recent transactions;

b) transactions yet to be recorded on a passbook (unrecorded transactions); and

c) transactions yet to be confirmed by the customer (unconfirmed transactions).

The financial institution or the like that manages the host server 20 may set such criteria as required.

This embodiment has adopted criterion a). In this case, the history data extracted by the unconfirmed-transaction processing section 24 consists of data about individual transactions plus record information and confirmation information. In other words, the history data extracted based on criterion a) contains the history data of the transactions yet to be confirmed by the customer.

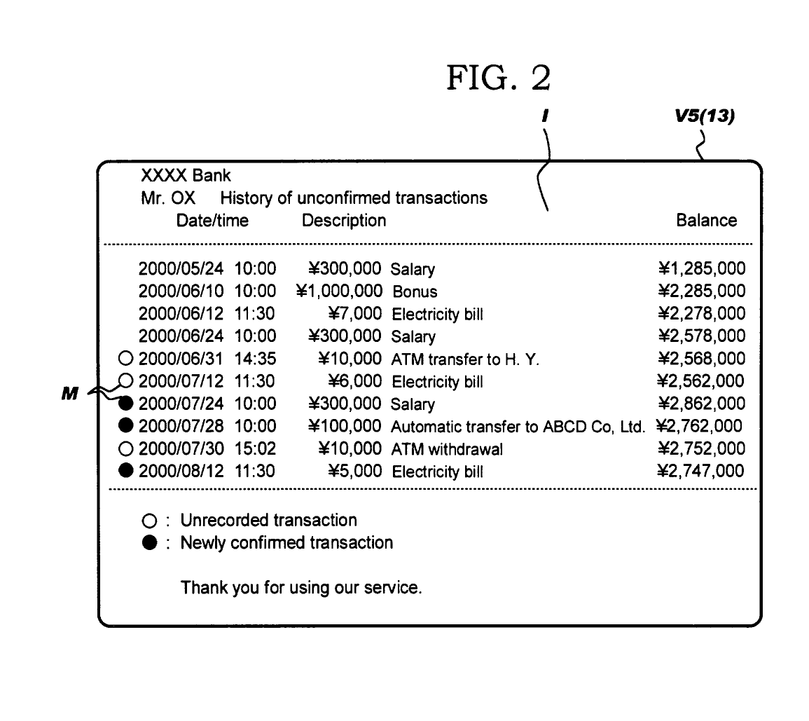

The transaction data extracted by the unconfirmed-transaction processing section 24 of the host server 20 is transferred to the ATM 10 via the leased line 30. Then, based on the transferred history data, the ATM 10 displays transaction history information I on the on-screen display section 13, for example, as shown in FIG. 2. According to this embodiment, which has adopted criterion a), a given number (e.g., 10) of recent transactions is displayed as the transaction history information I in the on-screen display section 13.

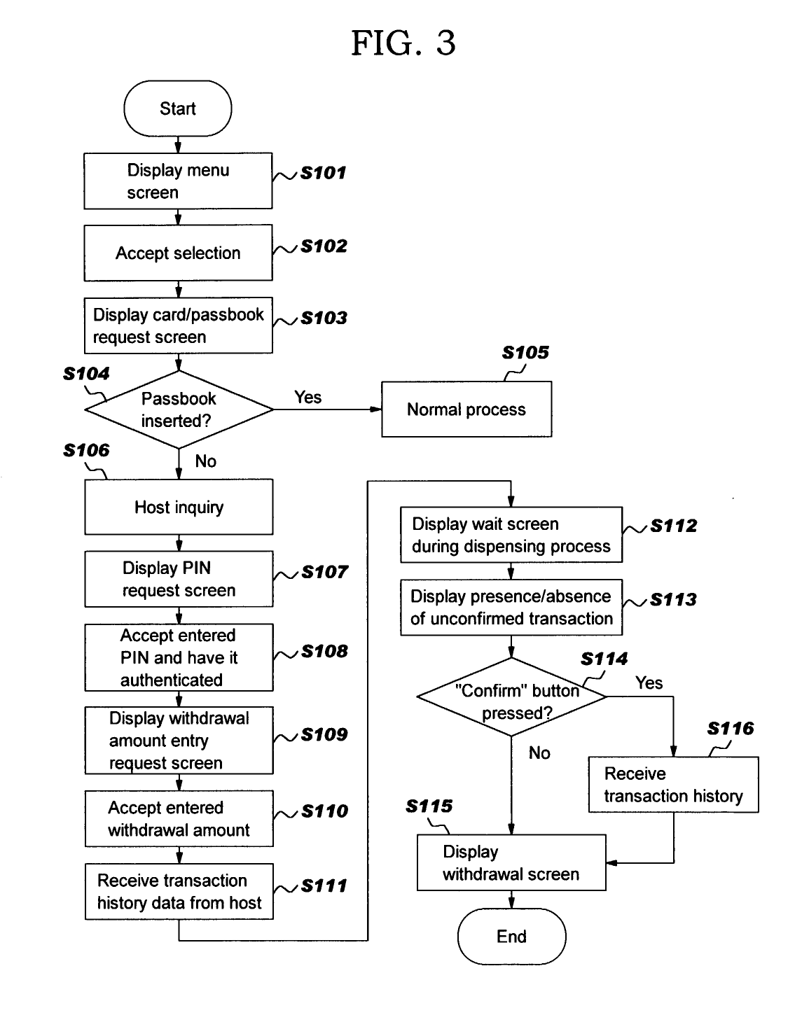

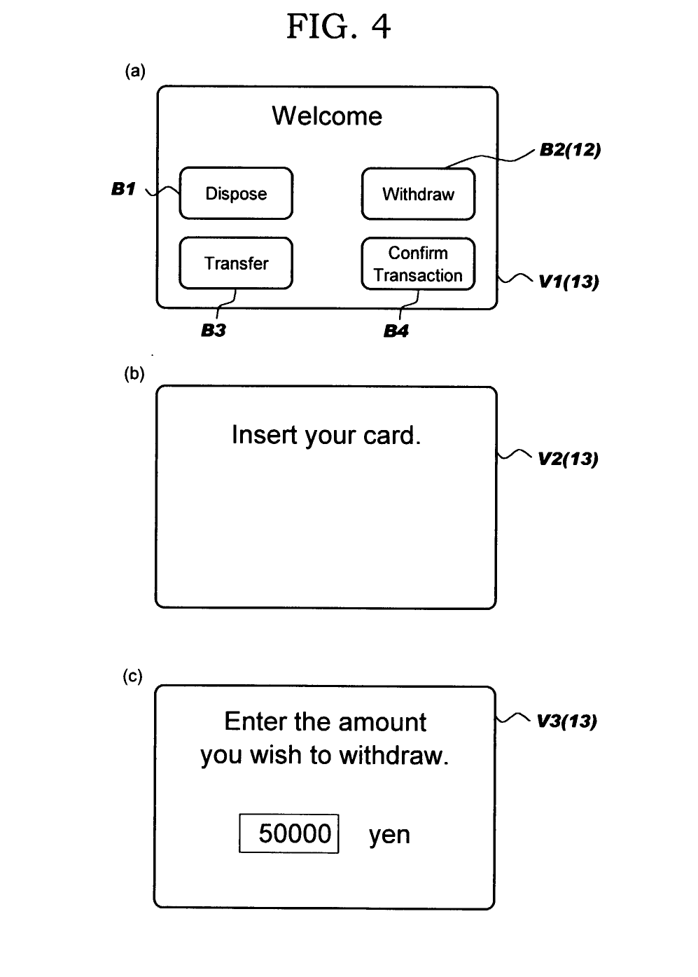

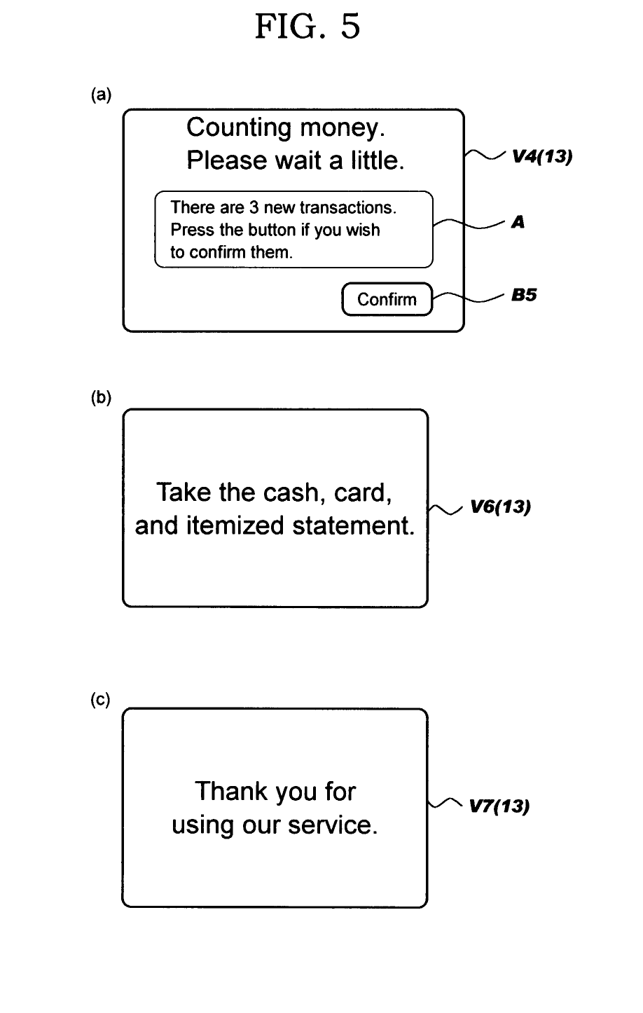

Now description will be given about a case in which an ATM 10 displays transaction history information I for a customer in the ATM system with the above configuration. FIG. 3 shows the flow of the processes executed by the control section 14 when the customer uses the ATM 10. FIGS. 4 and 5 show screen examples displayed in the on-screen display section 13 of the ATM 10 during the processing by the ATM 10.

The on-screen display section 13 of the ATM 10 brings up an initial screen, i.e., a menu screen V1 such as the one shown in FIG. 4A (Step S101: menu presentation process). The menu screen V1, which functions as the input section 12 shown in FIG. 1, displays buttons “Deposit” B1, “Withdraw” B2, “Transfer” B3, and “Confirm Transaction” B4 for the customer to select a desired transaction. Incidentally, the transactions shown on the menu screen V1 are simply exemplary and transactions may be added or changed as required.

From the buttons B1, B2, B3, and B4, the customer selects and operates the one that corresponds to the desired transaction, for example,“Withdraw” B2.

Then the ATM 10 accepts the selection (Step 102: menu specification process).

Next, the ATM 10 displays a screen V2, such as the one shown in FIG. 4B, in the on-screen display section 13, asking the customer to insert a cash card (Step S103). If the ATM 10 handles both cash cards and passbooks, it displays a request on the screen V2, asking the customer to insert a cash card and passbook.

In response to the message on the screen V2, the customer inserts a cash card in the card accepting section 15. If the ATM 10 handles both cash cards and passbooks, the customer can insert the passbook in a passbook accepting section 16 in addition to the cash card. The ATM 10 accepts the inserted cash card (and/or passbook).

In Step S104, the ATM 10 determines whether or not a passbook is inserted (determining process). If it is found that a passbook is inserted, the ATM 10 executes the transaction that corresponds to the customer's operation and records unrecorded transactions, i.e., carries out a normal process (Step S105: details are the same as with conventional ATMs and will be omitted). Steps S104 and S105 are performed only by ATMs 10 which handle both cash cards and passbooks and omitted by card-only ATMs 10.

When the ATM 10 accepts the cash card, it reads the customer's transaction account number (account number) from the magnetic data recording section of the cash card (acceptance process) and inquires of the host server 20 about the transaction history of the customer via the host communication section 11 based on the transaction account number (Step S106: reference process). After receiving the inquiry, the host server 20 identifies the transaction account by the transaction account number. Then, the unconfirmed-transaction processing section 24 searches the host database 23 as described above and extracts data about the transactions that meet given criteria (determining step). Regarding the criteria for extracting transaction data, it is assumed here that criterion a) , a given number (e.g., 10) of recent transactions is preset.

After Step S106, the ATM 10 displays a screen in the on-screen display section 13, prompting the customer to enter a personal identification number (Step S107).

In response to the prompt, the customer enters his/her personal identification number using a numeric keypad (not shown) displayed as the input section 12 in the on-screen display section 13.

The ATM 10 accepts the personal identification number and have it authenticated by the host server 20 via the host communication section 11 (Step S108).

Upon receiving authentication from the host server 20, the ATM 10 displays a screen V3 (see FIG. 4C) in the on-screen display section 13, prompting the customer to enter a withdrawal amount (Step S109).

In response to the prompt, the customer enters a withdrawal amount using a numeric keypad (not shown) displayed as the input section 12 in the on-screen display section 13. The ATM 10 accepts the input of the withdrawal amount (Step S110).

While the ATM 10 is performing the Steps S107 to 110 described above, the host server 20 extracts the transaction history data which satisfies the given criterion from the host database 23 in response to the inquiry made by the ATM 10 in Step S106 described above. Then, the ATM 10 receives the extracted transaction history data outputted by the host server 20 (Step S111). Incidentally, although Step S111 is placed after Step S110 for convenience of explanation, actually the ATM 10 receives transaction history data from the host at the proper time (when the host server 20 completes extraction and output) after Step S106.

Then, the ATM 10 runs a dispensing process for the withdrawal amount accepted in Step S110. In the meantime, it displays a wait screen V4, such as the one shown in FIG. 5A, in the on-screen display section 13 (Step S112: notification process).

The wait screen V4 is designed to display information A about the existence of transactions yet to be confirmed by the customer (transactions other than those made by the customer himself/herself), based on the transaction history data received from the host server 20. In this example, the information A includes the number of transactions yet to be confirmed by the customer (Step S113).

Next, the ATM 10 detects whether a “Confirm” button B5 displayed on the wait screen V4 is operated (Step S114: specification process). If no operation of the “Confirm” button B5 is detected within a preset time, the ATM 10 goes to Step S115.

On the other hand, if the customer who views the information A displayed in Step S113 operates the “Confirm” button B5 displayed on the wait screen V4 and the ATM 10 detects the confirmation operation, the ATM 10 displays a transaction history confirmation screen V5 (see FIG. 2) in the on-screen display section 13, based on the transaction history data received from the host server 20 (Step S116: information output process and display process)

On the transaction history confirmation screen V5, the customer can view transaction history information I about the latest ten transactions.

At this time, the transaction history information I contains identification marks M such as ◯ and ●. For example, unrecorded transactions are marked by ◯ and the transactions not yet confirmed by the customer till just before the transaction history confirmation screen V5 was displayed are marked by ●.

In the example of FIG. 2, the transaction history up to Jun. 24, 2000 was already entered, transaction history was confirmed between Jul. 12, 2000 and Jul. 24, 2000 and then the transaction history confirmation screen V5 was displayed after Aug. 12, 2000.

Thus, it can be seen that the transaction history information I contains information about unrecorded transactions and information about transactions yet to be confirmed by the customer. In the transaction history information I which is displayed on the transaction history confirmation screen V5, the transaction information outputted with the ● mark attached represents history information about the transactions not made by the customer himself/herself, yet-to-be-output transaction information, unconfirmed information yet to be confirmed by the customer, and information about the transactions other than those made by the customer himself/herself, according to this embodiment.

When the transaction history confirmation screen V5 is displayed, a notice to that effect is sent by the ATM 10 to the host server 20. Upon receiving the notice, the host server 20 updates the flags and pointers which represent confirmation information of the transaction data stored in the host database 23. From this time forward, the transactions displayed on the confirmation screen V5 this time are treated as transactions confirmed by the customer.

Thus, after the transaction history confirmation screen V5 is displayed, if a given event occurs—for example, if a given time elapses, or if the customer carries out a given confirmation-complete operation, or if the dispensing process reaches a given phase (e.g., when cash has been counted), the ATM 10 goes to Step S115.

In Step S115, the ATM 10 displays a withdrawal screen V6 such as the one shown in FIG. 5B and dispenses the amount of cash specified by the customer, from the deposit and withdrawal section 17. After the customer takes out the cash from the deposit and withdrawal section 17, the ATM 10 displays an exit screen V7 such as the one shown in FIG. 5C and completes a sequence of processes.

With the configuration described above, the ATM system outputs transaction history data about a given number of recent transactions, for example, the latest ten transactions, from the transaction history data of the customer's transaction account stored in the host database 23 of the host server 20, at the request of the ATM 10, and makes the transaction history to be displayed in the on-screen display section 13 of the ATM 10. The transaction history data output from the host database 23 contains identification marks M which indicate any unrecorded transactions or transactions yet to be confirmed by the customer. Consequently, the customer can view the history of unrecorded transactions and unconfirmed transactions in the on-screen display section 13. In this way, customers can view the history of unconfirmed transactions easily even if they do not carry a passbook or an ATM is a cash card-only machine which does not accept a passbook. Thus, customers can view their transaction history on any ATM 10. This improves convenience over conventional ATMs, with which the only way to view transaction history is to update the passbook.

Furthermore, when a customer inserts a cash card, for example, to withdraw money, the ATM 10 displays information A indicating the existence of unconfirmed transactions, so the customer can view the history of unconfirmed transactions in a timely manner. Besides, the information A and the transaction history confirmation screen V5 are displayed during a waiting time for the customer when the ATM 10 is performing a dispensing process, i.e., a mechanical operation of counting bank notes. This reduces wasted time, minimizes the occupancy time of the ATM per person, and allows transaction history to be displayed efficiently.

On the part of the financial institutions that operate ATM systems and the manufactures that produce ATMs 10, ATMs 10 with passbook functions can be replaced by those without passbook functions in various places since customers do not experience inconvenience as described above even if ATMs do not have passbook update function. Therefore, equipment expenses can be reduced especially when installing ATMs 10 anew or replacing existing ATMs.

If customers usually go no further than viewing transaction history in the on-screen display section 13 and update their passbooks only when unrecorded transaction history is accumulated to some extent, the ATM 10 will pull in and eject passbooks and write/read magnetic data to/from the passbooks less frequently than is conventionally the case in which transactions are entered each time a passbook is inserted in the ATM 10 because more transaction history will be recorded together at a time although the total number of transactions entered in the passbook will remain unchanged. This makes it possible, to reduce the maintenance cost of the passbook accepting section 16.

In the near future, it is conceivable that transaction history data will be stored in the memory of IC cards or the like provided with passbook function instead of being printed on multi-page passbooks made of paper. In the transitional period, both paper passbooks and IC cards are likely to be used. Even in such cases, it is possible to provide a passbook update service if, for example, one ATM out of a plurality of ATMs 10 is provided with passbook function or if a dedicated passbook update machine is installed along with ATMs 10 without passbook function. Therefore, the migration to IC cards will take place smoothly without hindering services to customers.

Also, even if transaction history data is stored in the memory of IC cards, transaction history can be displayed as well only if the ATM 10 described above is provided with a capability to read transaction history data from memory.

Although transaction history is displayed during a dispensing process after the “Withdraw” button B2 is pressed according to the above embodiment, the transaction history confirmation screen V5 may be displayed similarly during a given process after the “Deposit” button B1 or “Transfer” button B3 is pressed. Of course, pressing the “Confirm Transaction” button B4 displays the information A as to the existence and number of unconfirmed transactions as well as transaction history for the customer.

The timing for displaying the information A indicating the existence of unconfirmed transactions and the timing for displaying the transaction history confirmation screen V5 in the on-screen display section 13 are not limited to those shown in the above embodiment and they may be changed, as required, so as to reduce wasted time.

Furthermore, it is possible to display only the information A indicating the existence of unconfirmed transactions without displaying the transaction history confirmation screen V5 so that after viewing the information A, the customer will update his/her passbook.

The ATM 10 may be of a type that has the passbook accepting section 16 as described above or it may be a cash card-only machine that does not have the passbook accepting section 16. Besides, it is also possible to equip a dedicated passbook update machine with the on-screen display section 13 and card accepting section 15 or configure a transaction history display apparatus exclusively for use with cash cards to display the transaction history confirmation screen V5.

Although in the above embodiment, transactions are classified according to whether they are entered in the passbook and whether they have been confirmed by the customer, the criteria for classification may be changed as required.

Although in the above embodiment, the latest ten transactions are displayed in the on-screen display section 13 with identification marks ◯ and ● attached to unrecorded transactions and unconfirmed transactions, respectively, it goes without saying that the present invention may employ another method such as a color coded display. Besides, it is also possible to display only unrecorded transactions in such a way that unconfirmed transactions can be identified or to display only unconfirmed transactions rather than displaying the latest ten transactions by classifying them into types.

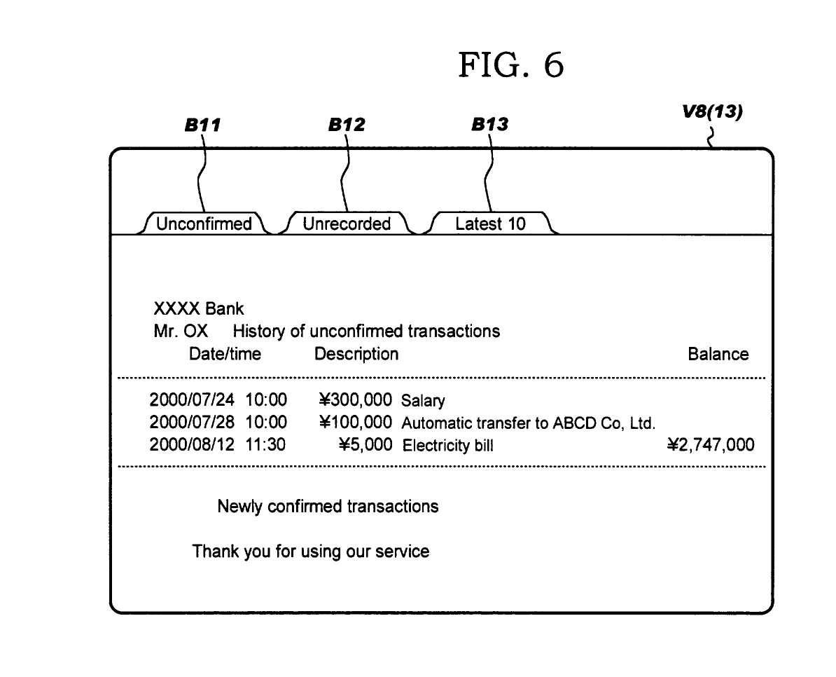

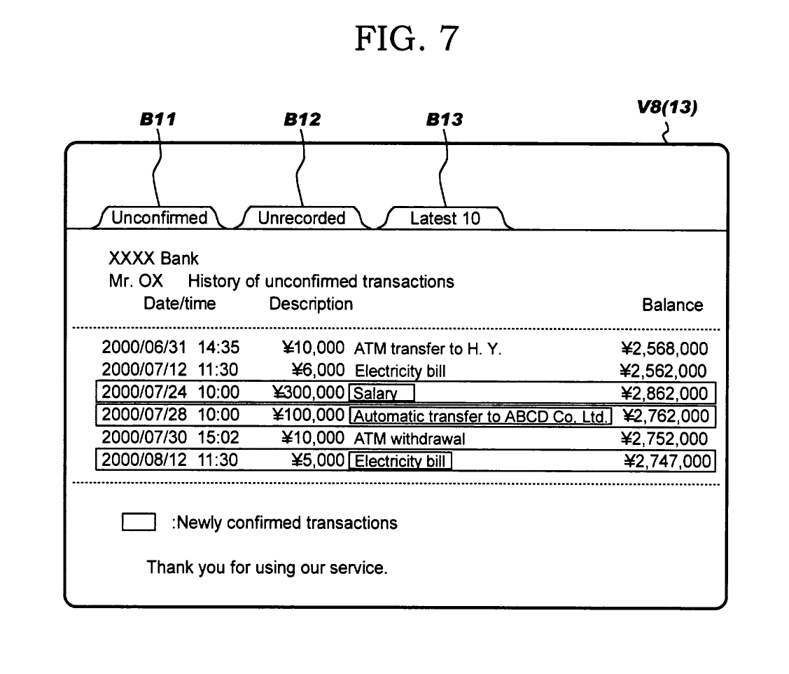

It is also possible to display a screen such as the one shown in FIGS. 6 and 7 in the on-screen display section 13. Namely, a screen V8 displayed in the on-screen display section 13 allows the customer to switch between different modes: a mode of displaying only unconfirmed transactions (see FIG. 6), a mode of displaying only unrecorded transactions in such a way that unconfirmed transactions can be identified (see FIG. 7), and a mode of displaying the latest ten transactions (the same transaction history as in FIG. 2). For this purpose, mode selection buttons B11, B12, and B13 are displayed on the screen V8.

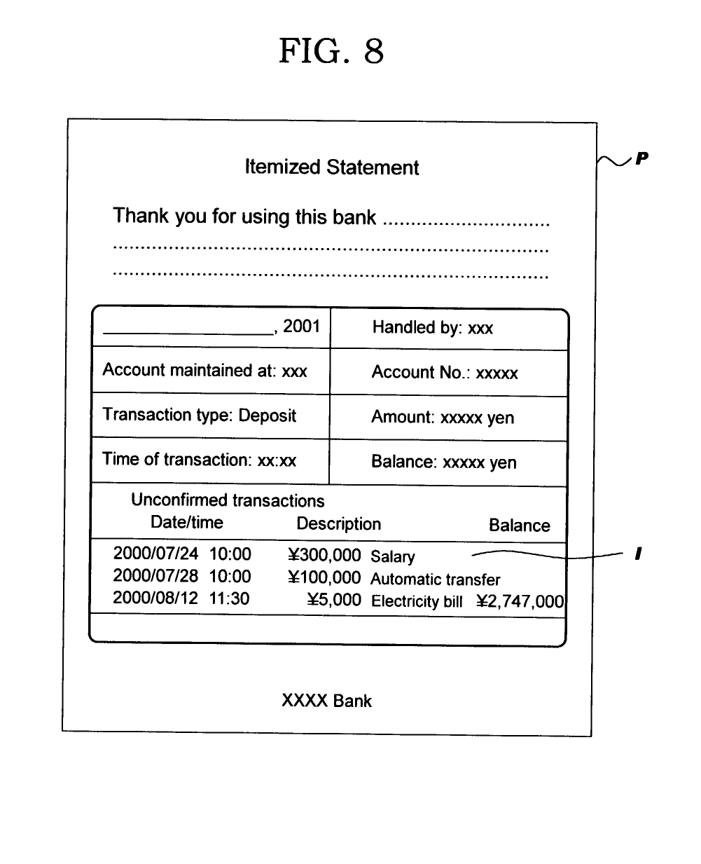

Although in the above embodiment, customers' transaction history information is displayed in the on-screen display section 13 of the ATM 10, the transaction history information I may be printed out on an itemized statement P issued by the itemized statement issuing section 18 of ATM 10 as shown in FIG. 8.

When printing the transaction history information I on the itemized statement P, the display in the on-screen display section 13 such as the one described in relation to the above embodiment may be either produced or omitted. It is also possible to print the transaction history information I on the itemized statement P only if the customer so desires when asked in the on-screen display section 13.

The programs for executing the processes described in relation to the above embodiment may be provided via a storage medium or a program-transmission device as follows.

Regarding the storage medium, the programs to be executed by the ATM 10 or a computer device such as the host server 20 can be stored in a storage medium such as a CD-ROM, DVD, memory, or hard disk in such a manner that they can be read by the computer device.

Also, the program-transmission device may comprise storage means such as a CD-ROM, DVD, memory, or hard disk for storing programs such as the ones described above, and transmission means for transmitting the programs via a connector or a network such as a LAN to the device that executes the programs by reading them from the storage means. Such a program-transmission device will be suitable especially when installing the programs that execute the processes described above on ATMs 10 in various places.

As described above, the present invention allows customers to check their transaction history even if they do not carry their passbook or if a terminal does not accept a passbook. This improves convenience for the customers.

Modifications may be made to the configuration of the above embodiment through selection or other configurations may be used as required without departing from the spirit and scope of the present invention.

What is claimed:

1. A transaction system, comprising a terminal for customers to make transactions and a server for holding information about transaction accounts of the customers,
wherein as said information about transaction accounts, said server possesses transaction history data concerning the transaction accounts and data for identifying whether each transaction was made by a customer himself/herself, and
in response to a particular operation by a customer, said terminal outputs history information about the transactions not made by the customer himself/herself, based on said information about transaction accounts held by said server.

2. The transaction system according to claim 1, wherein said terminal comprises a display section for displaying images and outputs said history information by displaying it on the display section.

3. A transaction terminal, comprising:
a specific-information accepting unit for accepting an input of account information for identifying a transaction account;
a history data receiving unit for identifying a transaction account based on said account information inputted and receiving, from an external database, at least a part of transaction history data of the transaction account which has not been output before;
a transaction detail accepting unit for accepting specification of transaction details with respect to said transaction account;
a transaction executing unit for executing a transaction based on the specified transaction details; and
an information output unit for outputting yet-to-be-output transaction information which has not been output before, based on the history data received by said history data receiving unit.

4. The transaction terminal according to claim 3,
wherein said history data receiving unit receives the transaction history data of said transaction account and identification data for identifying whether any output has been made for each transaction, and
said information output unit outputs said yet-to-be-output transaction information based on said history data and said identification data.

5. The transaction terminal according to claim 3, wherein said history data receiving unit receives transaction history data which has not been output before and which has been extracted from transaction history data of said transaction account.

6. The transaction terminal according to claim 3, wherein said information output unit outputs the existence and/or details of transactions for which no output has been made before, as said yet-to-be-output transaction information.

7. The transaction terminal according to claim 3, further comprising an itemized statement issuing unit for issuing an itemized statement by printing out transaction information about the transactions executed by said transaction executing unit and said yet-to-be-output transaction information.

8. The transaction terminal according to claim 3, wherein said information output unit outputs said yet-to-be-output transaction information when said transaction executing unit is executing a transaction based on the specified transaction details.

9. A transaction history output apparatus, comprising:
a card accepting section for accepting a card storing the transaction account number of a customer and reading said transaction account number;
a data reference section for referring to an external database for the transaction history data of the transaction account corresponding to said transaction account number; and
a history output section for outputting information about unconfirmed transactions yet to be confirmed by the customer, from said transaction history data.

10. The transaction history output apparatus according to claim 9, wherein said history output section outputs said information about unconfirmed transactions, information about unrecorded transactions yet to be entered in the passbook which records transaction history, and identification information which distinguishes between said information about unconfirmed transactions and said information about unrecorded transactions.

11. The transaction history output apparatus according to claim 9, wherein said history output section outputs information about a predetermined number of transactions as well as identification information which distinguishes between said unconfirmed transactions and other transactions among said predetermined number of transactions.

12. The transaction history output apparatus according to claim 9, wherein said history output section treats the transactions made by the customer himself/herself in the past as transactions confirmed by said customer.

13. A server which executes required processing at the request of a terminal operated by a customer, comprising:
a request accepting section for accepting requests from said terminal;
a data storage section for storing data about a transaction account of a customer; and
a data extraction section for extracting data from said data storage section, based on the request accepted by said request accepting section, and outputting the data to said terminal,
wherein said data storage section stores said data including:
history information about the transactions on the transaction account of said customer;
output information indicating whether or not the transactions contained in said history information have been output by said data extraction section; and
record information indicating whether or not said history data is recorded on a passbook which records transaction history of the transaction account of said customer.

14. The server according to claim 13, wherein said data extraction section outputs a part of the transaction history information which, according to said output information, has not been output by said data extraction section.

15. The server according to claim 13, wherein said data extraction section outputs said output information with said history information.

16. A transaction history display method for displaying a history of unrecorded transactions yet to be entered in the passbook of transactions on the transaction account of a customer, comprising:
a determining step of determining whether the type of the unrecorded transactions on the transaction account of the customer is a preset type; and
a display step of displaying the history of the transactions determined to be of said preset type.

17. The transaction history display method according to Claim 16, wherein said display step additionally displays the history of transactions of other types together with the history of the transactions determined to be of said preset type by attaching identification information for distinguishing between the history of the transactions determined to be of said preset type and history of the transactions of said other types.

18. The transaction history display method according to claim 16, wherein said type has been preset depending on whether or not a given transaction has been made by the customer himself/herself.

19. A computer program product comprising a computer useable medium having computer program logic recorded thereon for causing a computer that performs processes on a customer's transaction account based on the customer's operations to execute processes, said processes comprising:
an acceptance process of accepting an external input of information for identification of a transaction account and identifying the transaction account;
a reference process of referencing the transaction history of said transaction account; and
an information output process of outputting information about transactions other than those made by the customer himself/herself, based on said transaction history referenced.

20. The computer program product according to claim 19, wherein said processes further comprising:
a determining process of determining whether a passbook recording the transaction history of the transaction account is input in said computer,
wherein said information output process is executed if it is determined that said passbook is not input.

21. The computer program product according to claim 19, wherein said processes further comprising:
a menu presentation process of presenting a menu of processes including said information output process; and
a menu specification process of accepting the specification of a process to be executed on said computer from among the processes presented on the menu,
wherein even if the process specified in said menu specification process is other than said information output process, said information output process is executed during the execution of said specified process.

22. The computer program product according to claim 19, wherein said processes further comprising:
a notification process of indicating the existence of transactions other than the ones made by the customer himself/herself if reference to said transaction history in said reference process finds such transactions; and
a specification process of making a request to specify whether to output said transaction history and accepting an external input of specification made in response to the request,
wherein said information output process is executed if said transaction history is specified to be output in said specification process.
